(19) United States
(12) Patent Application Publication
(10) Pub. No.: US 2025/0138905 A1
(43) Pub. Date: May 1, 2025

(54) AUTOMATED WORKLOAD MIGRATION FRAMEWORK

(71) Applicant: Dell Products L.P., Round Rock, TX (US)

(72) Inventors: Nithiyanandham Tamilselvan, Salem (IN); Himanshu Shekhar, Bangalore (IN); Selva Kumar S, Bangalore (IN); Tanmoy Nath, Bongaigaon (IN); Dinesh Ginwali, Dehradun (IN); Mahasweta Keshri, Bangalore (IN); Amulya HN, Bangalore (IN)

(21) Appl. No.: 18/495,177

(22) Filed: Oct. 26, 2023

(51) Int. Cl. G06F 9/50; G06F 11/32

(52) U.S. Cl. CPC G06F 9/5088; G06F 9/5077; G06F 11/328

(57) ABSTRACT

Methods, apparatus, and processor-readable storage media for providing an automated workload migration framework are presented herein. An example computer-implemented method includes obtaining one or more requests for migrating a plurality of workloads, where the one or more requests comprise information corresponding to characteristics associated with the plurality of workloads. The process can include analyzing the one or more requests by applying one or more migration selection criteria to the characteristics associated with the plurality of workloads and selecting at least one of a plurality of migration services to use for migrating the plurality of workloads based on a result of the analyzing. The process can also include generating a set of instructions to migrate the plurality of workloads using the selected at least one migration service and automatically triggering the migration of the plurality of workloads based at least in part on the set of instructions.

### BACKGROUND

Workload migration generally refers to a process of moving one or more workloads, such as one or more programs and/or services, between environments. For example, a given workload can be moved between one or more datacenters and/or cloud platforms.

### SUMMARY

Illustrative embodiments of the disclosure provide a framework for automated workload migration. An exemplary computer-implemented method includes obtaining one or more requests for migrating a plurality of workloads, where the one or more requests include information corresponding to one or more characteristics associated with the plurality of workloads. The process can include analyzing the one or more requests by applying one or more migration selection criteria to the one or more characteristics associated with the plurality of workloads and selecting at least one of a plurality of migration services to use for migrating the plurality of workloads based on a result of the analyzing. The process can also include generating a set of instructions to migrate the plurality of workloads using the selected at least one migration service and automatically triggering the migration of the plurality of workloads based at least in part on the set of instructions.

Illustrative embodiments can provide significant advantages relative to conventional workload migration techniques. For example, technical challenges associated with the complexity of migrations involving multiple workloads and/or multiple tenants being moved to one or more new environments are mitigated in one or more embodiments by providing a workload migration framework that performs automated workload migrations across different migration services.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated workload migration in an illustrative embodiment.

FIG. 2 shows an example of a migration framework involving multiple migration services in an illustrative embodiment.

FIG. 3 shows an example of a migration workflow framework in an illustrative embodiment.

FIG. 4 is a workflow diagram for selecting migration services in an illustrative embodiment.

FIG. 5 is a flow diagram of a process for initializing migration workflows in an illustrative embodiment.

FIG. 6 is a flow diagram of an automated workload migration process in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources. Numerous different types of enterprise computing and storage systems are also encompassed by the term “information processing system” as that term is broadly used herein.

Workload migrations are often carefully planned and executed to ensure that applications and/or services remain accessible and functional following the migration. Migrations that involve multiple workloads and/or multiple tenants being moved to one or more new environments can be particularly challenging as each migration can require extensive manual efforts from users via command line interfaces (CLIs). Such techniques are often inefficient, costly, and prone to errors as they require frequent input from one or more users (e.g., migration engineers) during the migration process.

For example, in some situations, a user can initiate migrations sequentially, where each migration event can have multiple workloads (e.g., hundreds or more virtual machines (VMs)) to migrate. A significant amount of time can be spent monitoring the status of the migrations. Once a given migration is completed, the user then needs to configure the VMs in the target environment, such as by configuring one or more of the following: network ports, Internet Protocol (IP) addresses, installing one or more applications, and uninstalling one or more applications. To accomplish this, the user logs into each VM individually in the target environment and performs the changes.

One or more embodiments described herein provide an automated migration framework that can facilitate workload migrations (possibly having multiple workloads and/or involving multiple tenants) across multiple migration services. It is to be appreciated that the term “migration” as used herein is intended to be broadly construed so as to encompass, for example, moving workloads to, from, and/or between datacenters, including physical, virtual, and/or cloud-based datacenters. It is also to be appreciated that the term “workload” as used herein is intended to be broadly construed so as to encompass, for example, one or more applications, one or more services, one or more VMs, and/or other types of data.

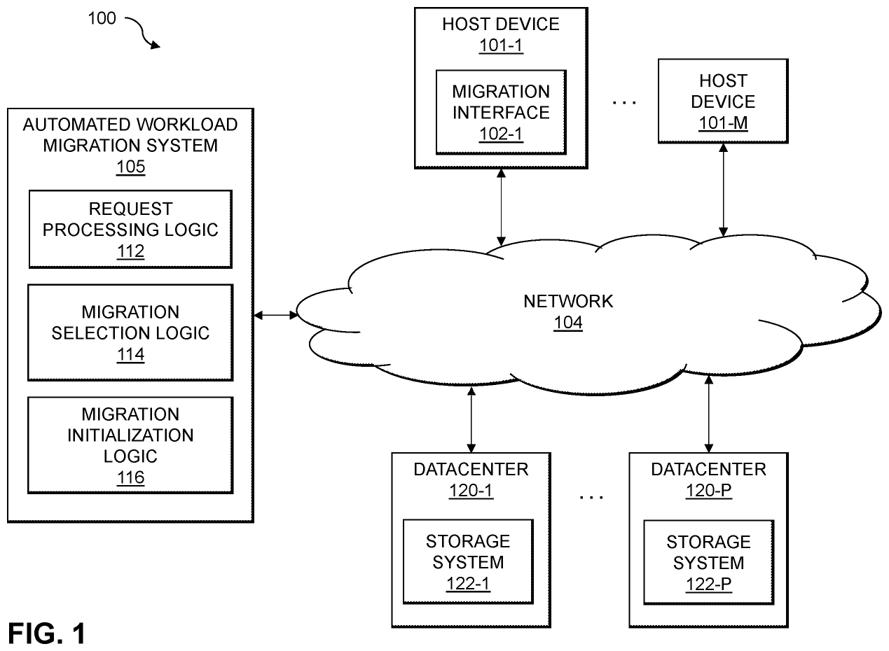

FIG. 1 shows an information processing system 100 configured for automated workload migration in accordance with an illustrative embodiment. The information processing system 100 comprises a plurality of host devices 101-1, . . . 101-M (collectively referred to herein as host devices 101) and a plurality of datacenters 120-1, . . . 120-P (collectively referred to herein as datacenters 120) having respective storage systems 122-1, . . . , 122-P (collectively referred to herein as storage systems 122). The information processing system 100 of FIG. 1 also comprises an automated workload migration system 105. The host devices 101 are configured to communicate with the storages systems 122 and/or the automated workload migration system 105 over a network 104.

The host devices 101 illustratively comprise servers or other types of computers of an enterprise computer system, cloud-based computer system or other arrangement of multiple compute nodes associated with respective users.

For example, the host devices 101 in some embodiments illustratively provide compute services such as execution of one or more applications on behalf of each of one or more users associated with respective ones of the host devices. Such applications illustratively generate input-output (IO) operations that are processed by one or more of the storage systems 122. The term “input-output” as used herein refers to at least one of input and output. For example, IO operations may comprise write requests and/or read requests directed to logical addresses of a particular logical storage volume of one or more of the storage systems 122. These and other types of IO operations are also generally referred to herein as IO requests.

In the FIG. 1 embodiment, the host device 101-1 includes a migration interface 102-1 for automating migration of workloads, as described in more detail herein. Although not explicitly shown in FIG. 1, it is to be appreciated that one or more of the other host devices 101 may also include a migration interface 102 in at least some embodiments.

The storage system 122-1 illustratively comprises processing devices of one or more processing platforms. For example, the storage system 122-1 can comprise one or more processing devices each having a processor and a memory, possibly implementing virtual machines and/or containers, although numerous other configurations are possible. The storage system 122-1 can additionally or alternatively be part of one or more cloud infrastructures.

The host devices 101 and one or more of the storage systems 122 may be implemented on a common processing platform, or on separate processing platforms. The host devices 101 are illustratively configured to write data to and read data from the storage systems 122 in accordance with applications executing on those host devices for system users.

The term “user” herein is intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using IP or other communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

It is assumed that storage system 122-1 comprises a plurality of storage devices and an associated storage controller. The storage devices store data of a plurality of storage volumes. For example, the storage volumes may illustratively comprise respective logical units (LUNs) or other types of logical storage volumes. It is noted that in the context of a Linux/Unix system, a volume relates to a Logical Volume Manager (LVM), which can be used to manage mass storage devices; a physical volume generally refers to a storage device or partition; and a logical volume is created by the LVM and is a logical storage device (e.g., a LUN) which can span multiple physical volumes. The term “storage volume” as used herein is intended to be broadly construed, and should not be viewed as being limited to any particular format or configuration.

The storage devices of the storage system 122-1 illustratively comprise solid state drives (SSDs). Such SSDs are implemented using non-volatile memory (NVM) devices such as flash memory. Other types of NVM devices that can be used to implement at least a portion of the storage devices include non-volatile random access memory (NVRAM), phase-change RAM (PC-RAM), magnetic RAM (MRAM), resistive RAM, and spin torque transfer magneto-resistive RAM (STT-MRAM), as non-limiting examples. These and various combinations of multiple different types of NVM devices may also be used. For example, hard disk drives (HDDs) can be used in combination with or in place of SSDs or other types of NVM devices in the storage system 122-1.

It is therefore to be appreciated that numerous different types of storage devices can be used in the storage system 122-1 in other embodiments. For example, a given storage system as the term is broadly used herein can include a combination of different types of storage devices, as in the case of a multi-tier storage system comprising a flash-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices.

In some embodiments, the storage system 122-1 illustratively comprises a scale-out all-flash distributed content addressable storage (CAS) system. A wide variety of other types of distributed or non-distributed storage arrays can be used in implementing the storage system 122-1 in other embodiments. Additional or alternative types of storage products that can be used in implementing a given storage system in illustrative embodiments include software-defined storage, cloud storage, object-based storage and scale-out storage. Combinations of multiple ones of these and other storage types can also be used in implementing a given storage system in an illustrative embodiment.

The term “storage system” as used herein is therefore intended to be broadly construed, and should not be viewed as being limited to particular storage system types, such as, for example, CAS systems, distributed storage systems, or storage systems based on flash memory or other types of NVM storage devices. A given storage system as the term is broadly used herein can comprise, for example, any type of system comprising multiple storage devices, such as NAS, storage area networks (SANs), direct-attached storage (DAS) and distributed DAS, as well as combinations of these and other storage types, including software-defined storage.

In some embodiments, communications between the host devices 101 and the storage system 122-1 comprise Small Computer System Interface (SCSI) or Internet SCSI (iSCSI) commands. Other types of SCSI or non-SCSI commands may be used in other embodiments, including commands that are part of a standard command set, or custom commands such as a “vendor unique command” or VU command that is not part of a standard command set. The term “command” as used herein is therefore intended to be broadly construed, so as to encompass, for example, a composite command that comprises a combination of multiple individual commands. Numerous other commands can be used in other embodiments.

For example, although in some embodiments certain commands used by the host devices 101 to communicate with the storage system 122-1 illustratively comprise SCSI or iSCSI commands, other embodiments can implement IO operations utilizing command features and functionality associated with NVM Express (NVMe), as described in the NVMe Specification, Revision 1.3, May 2017, which is incorporated by reference herein. Other storage protocols of this type that may be utilized in illustrative embodiments disclosed herein include NVMe over Fabric, also referred to as NVMeoF, and NVMe over Transmission Control Protocol (TCP), also referred to as NVMe/TCP.

The host devices 101 are configured to interact over the network 104 with the storage system 122-1. Such interaction illustratively includes generating IO operations, such as write and read requests, and sending such requests over the network 104 for processing by the storage system 122-1. In some embodiments, each of the host devices 101 comprises a multi-path input-output (MPIO) driver configured to control delivery of IO operations from the host device to the storage system 122-1 over selected ones of a plurality of paths through the network 104. The paths are illustratively associated with respective initiator-target pairs, with each of a plurality of initiators of the initiator-target pairs comprising a corresponding host bus adaptor (HBA) of the host device, and each of a plurality of targets of the initiator-target pairs comprising a corresponding port of the storage system 122-1.

The MPIO driver may comprise, for example, an otherwise conventional MPIO driver.

The storage system 122-1 may further include one or more additional modules and other components typically found in conventional implementations of storage controllers and storage systems, although such additional modules and other components are omitted from the figure for clarity and simplicity of illustration.

In some embodiments, the storage system 122-1 is implemented as a distributed storage system, also referred to herein as a clustered storage system, comprising a plurality of storage nodes. Each of at least a subset of the storage nodes illustratively comprises a set of processing modules configured to communicate with corresponding sets of processing modules on other ones of the storage nodes. The sets of processing modules of the storage nodes of the storage system 122-1 in such an embodiment collectively comprise at least a portion of the storage controller of the storage system 122-1. For example, in some embodiments the sets of processing modules of the storage nodes collectively comprise a distributed storage controller of the distributed the storage system 122-1. A “distributed storage system” as that term is broadly used herein is intended to encompass any storage system that is distributed across multiple storage nodes.

It is assumed in some embodiments that the processing modules of a distributed implementation of a storage controller are interconnected in a full mesh network, such that a process of one of the processing modules can communicate with processes of any of the other processing modules. Commands issued by the processes can include, for example, remote procedure calls (RPCs) directed to other ones of the processes.

The sets of processing modules of a distributed storage controller illustratively comprise control modules, data modules, routing modules and at least one management module. Again, these and possibly other modules of a distributed storage controller are interconnected in the full mesh network, such that each of the modules can communicate with each of the other modules, although other types of networks and different module interconnection arrangements can be used in other embodiments.

The management module of the distributed storage controller in this embodiment may more particularly comprise a system-wide management module. Other embodiments can include multiple instances of the management module implemented on different ones of the storage nodes. It is therefore assumed that the distributed storage controller comprises one or more management modules.

A wide variety of alternative configurations of nodes and processing modules are possible in other embodiments. Also, the term “storage node” as used herein is intended to be broadly construed, and may comprise a node that implements storage control functionality but does not necessarily incorporate storage devices.

Communication links may be established between the various processing modules of the distributed storage controller using well-known communication protocols such as TCP/IP and remote direct memory access (RDMA). For example, respective sets of IP links used in data transfer and corresponding messaging could be associated with respective different ones of the routing modules.

Each storage node of a distributed implementation of a given one of the storage systems 122 illustratively comprises a CPU or other type of processor, a memory, a network interface card (NIC) or other type of network interface, and a subset of the storage devices, possibly arranged as part of a disk array enclosure (DAE) of the storage node. These and other references to “disks” herein are intended to refer generally to storage devices, including SSDs, and should therefore not be viewed as limited to spinning magnetic media.

The automated workload migration system 105 includes request processing logic 112, migration selection logic 114, and migration initialization logic 116, which facilitate the migration of workloads to, from, and/or between datacenters 120, as described in more detail elsewhere herein.

Generally, the request processing logic 112 includes functionality to determine workloads that need to be migrated and details related to such workloads by processing one or more migration requests. The migration selection logic 114 can select one or more migration services to use for migrating the workloads based at least in part on the details determined by the request processing logic 112. The migration initialization logic 116 can initiate a migration of the workloads using the selected migration services.

Each of the storage system 122-1 and the automated workload migration system 105 in the FIG. 1 embodiment is assumed to be implemented using at least one processing platform, with each such processing platform comprising one or more processing devices, and each such processing device comprising a processor coupled to a memory. Such processing devices can illustratively include particular arrangements of compute, storage and network resources. As indicated previously, the host devices 101 may be implemented in whole or in part on the same processing platform as the storage system 122-1, or on a separate processing platform. In at least some embodiments, at least a portion of the automated workload migration system 105 may be implemented in whole or in part on the same processing platform as the storage system 122-1 and/or the storage system 122-1, or on a separate processing platform.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the host devices 101 and the storage system 122-1 to reside in different data centers. Numerous other distributed implementations of the host devices 101, storage system 122-1, and the automated workload migration system 105 are possible.

In the FIG. 1 embodiment, the other storage systems 122 may be implemented in any one of the ways described above with respect to storage system 122-1. In at least some embodiments, one or more of the storage systems 122 implement at least one different type of storage array.

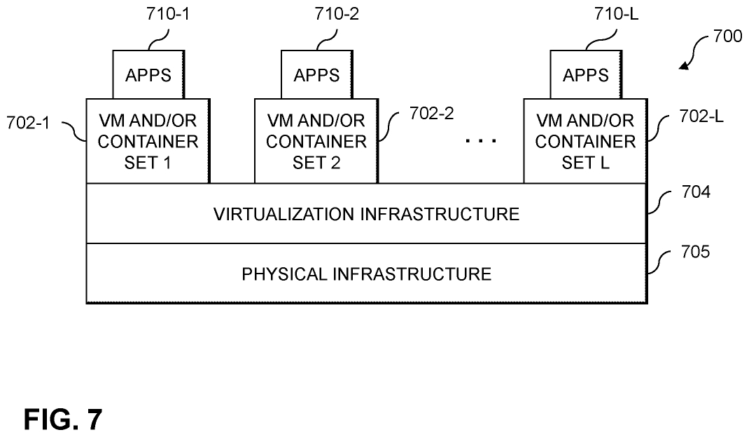

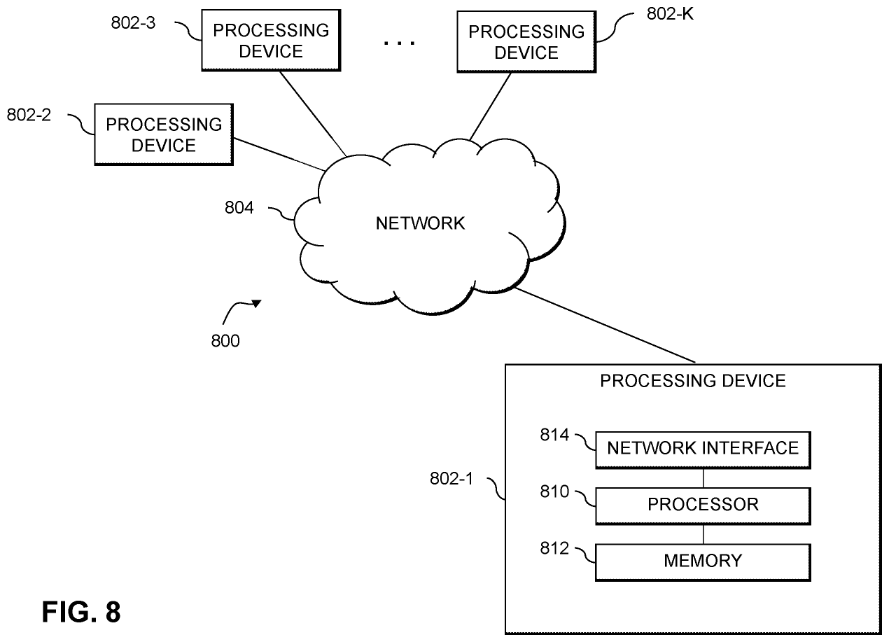

Additional examples of processing platforms utilized to implement the host devices 101, the storage systems 122, and the automated workload migration system 105 in illustrative embodiments will be described in more detail below in conjunction with FIGS. 7 and 8.

It is to be appreciated that these and other features of illustrative embodiments are presented by way of example only, and should not be construed as limiting in any way.

Accordingly, different numbers, types and arrangements of system components such as the host devices 101, the datacenters 120, storage systems 122, the automated workload migration system 105, and the network 104 can be used in other embodiments.

It should be understood that the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations.

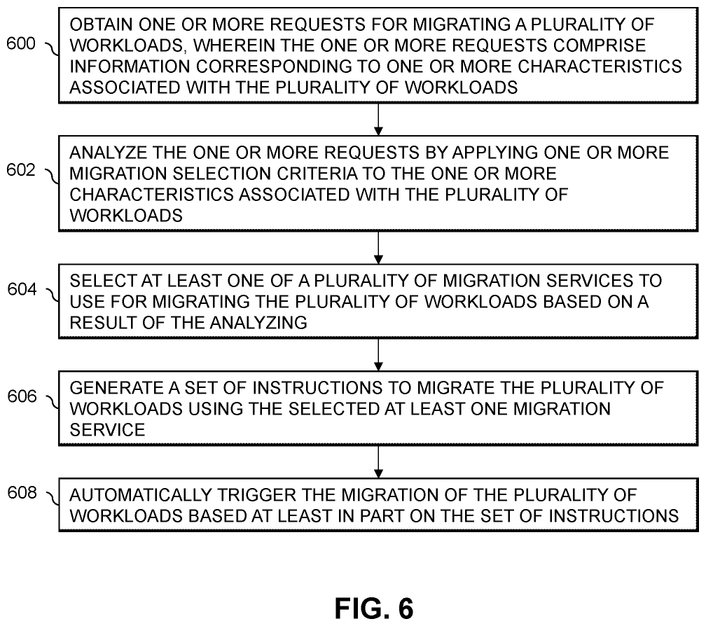

An exemplary process utilizing the automated workload migration system 105 will be described in more detail with reference to the flow diagram of FIG. 6.

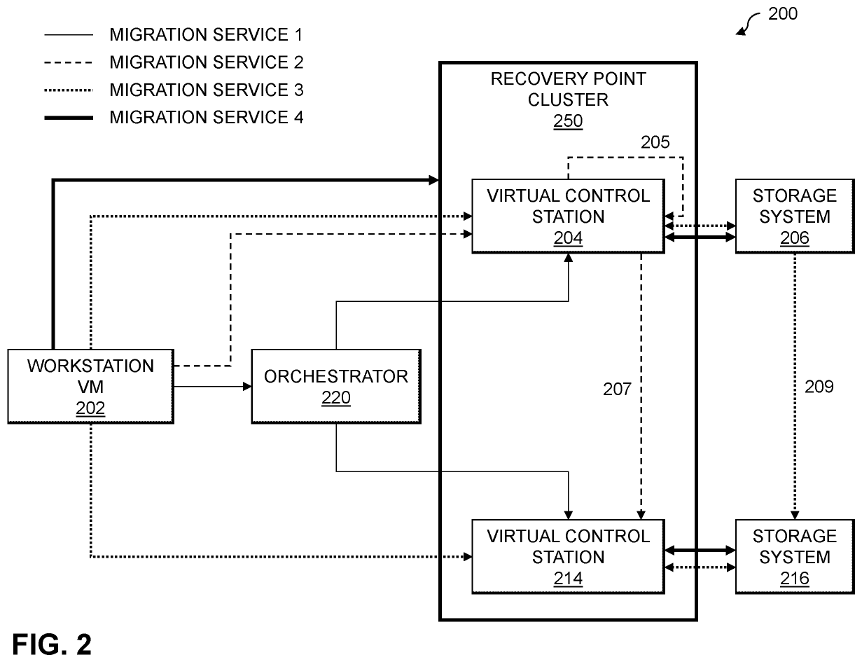

FIG. 2 shows an example of a migration framework 200 involving multiple migration services in an illustrative embodiment. FIG. 2 shows workflows for migration services 1-4, which are used by a workstation VM 202 to manage workload migrations. In this example, it is assumed that the workloads are associated with virtual control stations 204 and 214 and storage systems 206 and 216. The storage systems 206 and 216 may be implemented as given ones of storage systems 122 from FIG. 1, for example, and the virtual control stations 204 and 214 may be implemented as software for managing VMs associated with one or more users (e.g., corresponding to host devices 101).

In the FIG. 2 example, it is assumed that migration service 1 is configured to perform a workload migration associated with virtual control station 204 and virtual control station 214 using orchestrator 220. The workflow associated with migration service 1 is indicated by the solid arrows. More generally, migration service 1 can enable moving a complete server (referred to as a source server), to another server (referred to as a target server) by mirroring an image of the source server to the target server. It is noted that the source and/or target servers can comprise physical and/or virtual servers. The image of the source server includes the system state, such as the operating system and/or applications of the source server, as well as data associated with the source server. It is to be appreciated that migration service 1 can also be implemented to migrate only the data associated with the source server, in which case the target server's system state will be used with the source server's data. The migration service 1 can perform replication to keep the image of the source that is stored on the target up to date. For example, migration service 1 can replicate, in substantially real-time, file changes (as opposed to entire files), allowing resources to be used more efficiently. When the user is ready to complete the migration, the migration service 1 can apply the source system state, such that the source server becomes available on computing resources of the target server. Accordingly, automated job types associated with migration service 1 can include, for example, creating a workload job, performing a failover job (e.g., switching a workload to the target), and/or deleting a workload job.

In some embodiments, migration service 2 corresponds to a VM migration service that is configured to migrate one or more VMs associated with one or more of the virtual control stations. For example, migration service 2 can include different types of VM migration services, such as a host only migration service, where a VM is moved from one host to another, a storage migration service, where a datastore of a VM can be moved, and an enhanced migration service, where a VM can be moved from a first environment to a different environment, while switching adapters and datastores. In the FIG. 2 example, workflows associated with migration service 2 are represented using dashed arrows. It is noted that arrow 205 can correspond to a host only migration type or storage migration service type, and arrow 207 corresponds to an enhanced migration service type.

In at least some embodiments, migration service 3 can include a SAN migration service. The workflow associated with migration service 3 is represented using dotted arrows in FIG. 2. Generally, a SAN migration service can include performing a snapshot operation of a source LUN associated with a VM, and then zoning the source LUN to a target LUN. A re-signature process at the target LUN is used to register the VM. After the VM has been registered, an IP address can be assigned, packages can be installed, and any add-on commands can be executed, if needed. In some embodiments, the SAN migration service can implement a CLI (e.g., a PowerShell-based CLI) for managing the migrations. For example, migration service 3 can include functionality for shutting down VMs, renaming a source VM, re-signaturing a datastore, registering a VM, performing a snapshot operation, changing a network adapter, assigning an IP address, installing one or more packages, performing one or more add-on commands, and performing a reboot of one or more VMs. If a migration job fails for a given VM, then the remaining migration activity for that VM may stop, and other VM migration activity can proceed. In the example shown in FIG. 2, it is assumed that migration service 3 is used by the workstation VM 202 in FIG. 2 to generate a LUN snapshot of storage system 206 at storage system 216, as indicated by arrow 209.

Migration service 4, in some embodiments, can correspond to a VM data protection migration service that can enable local replication, remote replication, and concurrent local and remote replication with continuous data protection for on-premises recovery for VMs. Such a VM data protection migration service can enable, for example, automation for protecting VMs, adding VMs to a consistency group (CG), performing failovers, changing a network adapter, IP address re-assignment, and unprotecting VMs, for example. The workflow associated with migration service 4 in the FIG. 2 example is represented by bold arrows. It is also assumed that the virtual control stations 204 and 214 form a recovery point cluster 250 associated with migration service 4. For example, one or more of the virtual control stations 204 and 214 can implement a recovery point plugin that enables migration of VMs using migration service 4.

In some embodiments, the functionality associated with one or more migration services is accessed via one or more application programming interfaces (APIs), which may include one or more representational state transfer (REST) APIs, for example.

As an example, at least one API can be implemented for migration service 2 and/or migration service 4 to enable workstation VM 202 to access virtual control station 204 and/or virtual control station 214. As another example, at least one API can be implemented for migration service 1 to enable workstation VM 202 to access orchestrator 220 and/or enable orchestrator 220 to access virtual control station 204 and/or virtual control station 214.

Although the example shown in FIG. 2 implements four types of migration services, it is to be appreciated that in other embodiments there can be different types of migration services and/or a different number of migration services.

In some embodiments, an automated workload migration system can obtain one or more workload migration requests (e.g., from a customer). As a non-limiting example, the workload migration requests can be obtained in the form of one or more files that include information about workloads to be migrated. The automated workload migration system can analyze the information to select at least one of a plurality of migration services to be used for the migration. In one such embodiment, the automated workload migration system can provide a migration interface that enables users to select and/or manage migrations across different migration services. For example, a user can select one of a plurality of migration technologies from the interface and provide a set of workloads (e.g., a list of servers) to be migrated. The user can provide details about the migrations via the interface, and the automated workload migration system can then automate the migration job workflow without needing further user intervention, for example.

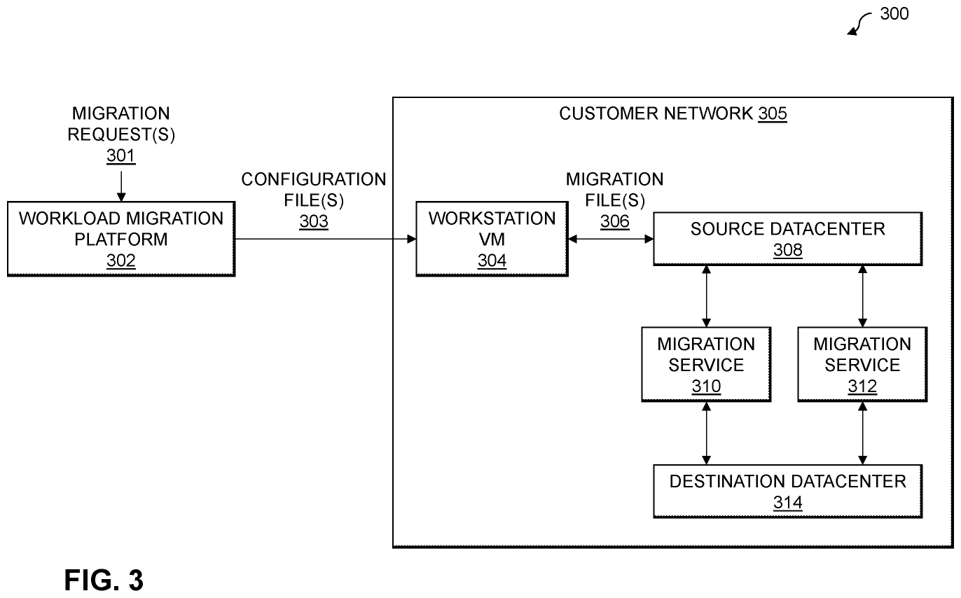

FIG. 3 shows an example of a migration workflow framework 300 in an illustrative embodiment. FIG. 3 includes a workload migration platform 302 and a customer network 305. In this example, it is assumed that the workload migration platform 302 obtains one or more migration requests 301 that include information pertaining to one or more workloads. In at least one embodiment, the migration requests 301 can be provided using one or more forms and/or catalogs. For example, a user, such as a migration engineer associated with a customer or organization, may enter information into a form or catalog via a website associated with the workload migration platform 302. The data can then be transformed into at least one configuration file 303. In the FIG. 3 example, it is assumed that the at least one configuration file 303 is provided to a workstation VM 304 of the customer network 305 to automate the workload migration between a source datacenter 308 and a destination datacenter 314 using migration services 310 and 312.

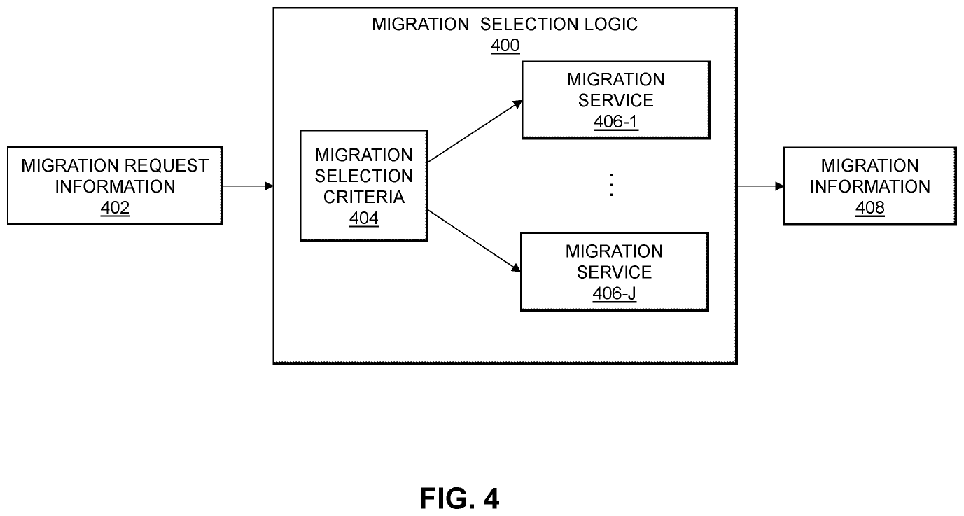

For example, in some embodiments the at least one configuration file 303 can be used to generate one or more migration files 306 (or scripts) that configure the migration services 310 and 312 to migrate the one or more workloads associated with the one or more migration requests 301. An example of initializing migration workflows is described in more detail in conjunction with FIG. 4.

It is noted that the workload migration platform 302 is shown as a separate component from the customer network 305 in the FIG. 3 example. However, it is to be appreciated that in other embodiments at least a portion of the workload migration platform 302 can be implemented within customer network 305, such as being implemented by workstation VM 304.

One or more embodiments can provide a user interface (e.g., corresponding to migration interface 102-1) for multiple types of migration services. The user interface can be used to execute and/or manage multiple types of workload migrations. As an example, the migration interface can enable a user to select a particular migration service from a set of migration services available in a unified migration interface. It is to be appreciated that different options and/or functionality are relevant to different migration services. Accordingly, the user interface can present such specific options for the selected migration service. As a non-limiting example, the user interface can include the following options for a first type of migration service (such as migration service 1 in the FIG. 2 example): creating and running a migration job; performing a failover to a target datacenter; and deleting an existing migration job.

The migration interface may also include the following options for a second type of migration service (such as migration service 2 in the FIG. 2 example): performing a host-only migration; performing a storage-only migration; and performing an enhanced migration.

Some options that can be presented to a user for a third type of migration service (such as migration service 3 in FIG. 2) include an option for validating the suitability of a destination cluster with respect to one or more resource types (e.g., processing and/or memory resources), an option for shutting down one or more VMs at a source datacenter, and an option to perform parallel execution of migration activities. Such migration activities can include, for example, shutting down VMs, renaming a source VM, datastore re-signaturing, registering a VM, performing a snapshot operation, changing a network adapter, assigning an IP address, installing one or more packages, performing one or more add-on commands, and performing a reboot. If a job fails for a given VM, then the remaining migration activity for that VM may stop, and the other VM migration activity can proceed. Other options can include rerunning a failed migration for workloads which failed, for example, due to a resource overload at the destination VM. The user interface can further include a sub-menu for executing one or more options separately across multiple migration jobs. For example, a shutdown option in the sub-menu can be provided to shut down all source VMs.

The migration interface may also include the following options for a fourth type of migration service (such as migration service 4 in FIG. 2): protecting one or more VMs, adding one or more VMs to an existing CG; a failover option; protecting one or more VMs using an existing VM/RDM (raw device mapping) protection; a package installation option for installing packages in migrated VM; and an option to execute one or more add-on commands (e.g., to execute any add-on commands in the migrated VM). If the failover option is selected, then additional options may be presented, such as one or more of the following: an option to shutdown source VMs; an option to update a VM sequence for failover; an option to change a network adapter; an option to reassign an IP address to a destination VM; an option to failover to a copy VM; and an option to enable direct access to a copy VM.

As noted elsewhere herein, a given configuration file can include information related to one or more migration jobs. As a non-limiting example, a given configuration file may include a plurality of fields related to one or more migration services, and information for attributes for each migration service. For example, the attributes can correspond to one or more of: a request identifier, a name of a workload to be migrated, an email associated with the request, network information (e.g., ports and/or IP address of the source and/or the target environment), authentication information (e.g., username and password), and other attributes related to workload migrations.

FIG. 4 shows an example of migration selection logic 400 in an illustrative embodiment. The migration selection logic 400 can correspond to migration selection logic 114 of the automated workload migration system 105, for example. The migration selection logic 400 obtains migration request information 402, which can comprise information related to one or more workload migration requests. The migration request information 402 can correspond to, or be used to generate, one or more configuration files (e.g., configuration files 303), for example.

In the FIG. 4 example, the migration selection logic 400 includes one or more migration selection criteria 404 that are mapped to multiple migration services 406-1, . . . 406-J (collectively referred to herein as migration services 406). The migration selection criteria 404 can be used to analyze the migration request information 402 to determine one or more of the migration services 406 that are suitable for a given migration. In some embodiments, the migration selection criteria 404 can specify respective sets of attributes for the migration services 406. In at least some embodiments, a given one of the migration services 406 can be selected based on a comparison of attributes identified from the migration request information 402 to the sets of attributes corresponding to the migration services 406.

By way of example, if the migration selection criteria 404 determines that the migration request information 402 relates to migrating a physical host (e.g., an ESXi host) and/or migrating one or more applications, then an automated data migration service (e.g., migration service 1 in FIG. 2) can be selected to perform the migration.

Also, if the migration selection criteria 404 determines that the migration request information 402 relates to migrating a VM within a virtual control station, migrating a datastore, and/or migrating a network adapter, then a VM migration service, such as migration service 2, can be selected to perform the migration. As another example, if the migration selection criteria 404 determines that the migration request information 402 relates to migrating storage devices and/or upgrading storage hardware, then a SAN migration service, such as migration service 3, can be selected to perform the migration.

As yet another example, if the migration selection criteria 404 determines that the migration request information 402 involves migrating a VM between virtual control stations (e.g., between virtual control station 204 and virtual control station 214), then a VM data protection migration service (e.g., migration service 4 in FIG. 2) can be selected for the migration.

Migration information 408 is generated based on the one or more selected migration services and the migration request information 402. For example, the migration information 408 can correspond to one or more scripts that are used to execute a migration job using the one or more selected migration services. As an example, the script can be generated based on variables in the migration request information 402 (e.g., names of workloads or VMs to be migrated, network information of the target datacenter and/or destination datacenter, authentication information, and/or any other information relevant to performing the migration).

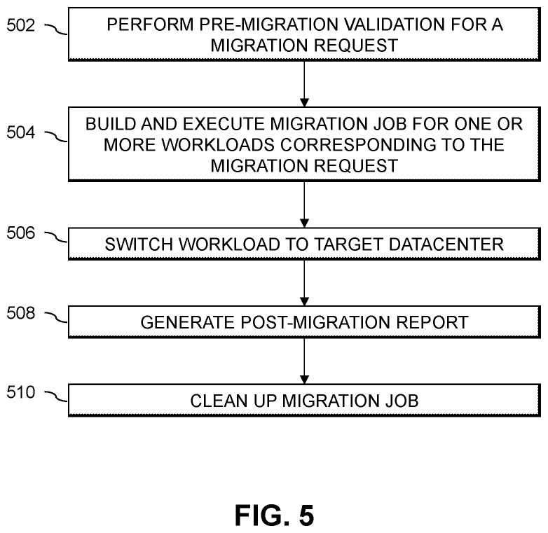

FIG. 5 is a flow diagram of a process for initializing migration workflows in an illustrative embodiment. In this embodiment, the process includes steps 502-510 and is assumed to be performed at least in part by the migration initialization logic 116.

Step 502 includes performing a pre-migration validation for a migration request. As a non-limiting example, the migration request can be related to transferring one or more workloads from a source datacenter to a target datacenter related to a customer or organization. In some embodiments, the pre-migration validation can include verifying that there are sufficient resources at the target datacenter. For example, in embodiments where the automated workload migration system 105 is implemented within a customer network, the migration initialization logic 116 can connect to a source datacenter and a target datacenter to validate that there are sufficient resources (e.g., CPU, memory, and/or headroom) at the target datacenter for transferring the one or more workloads. Optionally, the results of the validation can be provided to a user as part of step 502.

Step 504 includes building and executing a migration job for one or more workloads corresponding to the migration request. For example, the migration job can be built based at least in part on the migration information 408 output by the migration selection logic 400. For example, step 504 can include generating one or more script files and/or one or more variable data files (also referred to as .var files) that are used to execute the migration job.

Step 506 includes switching (also referred to as “failing over”) the workload to the target datacenter.

Step 508 includes generating a post-migration report. For example, the post-migration report can include various metrics related to the migration, such as whether the one or more workloads were successfully migrated, whether any of the workloads failed, and/or other characteristics associated with the migration job.

Step 510 includes cleaning up the migration job. For example, any files and/or data that are no longer needed can be removed, and possibly one or more applications that were used during the migration job can be removed.

Accordingly, some embodiments described herein are configured to automate various migration operations across multiple different migration services in a unified manner. In some embodiments, migration options and features for multiple migration services can be managed using a unified migration interface. For example, functionality for validating a cluster suitability with respect to resources for SAN migrations can be automatically validated and migration jobs for VMs that failed (e.g., due to resources becoming overloaded at the destination environment) can be automatically re-executed. Also, various migration properties (such as network configuration, IP assignment, failover options, failover identity, and mirroring options) can be automatically configured in accordance with a migration request (e.g., provided by one or more users), and features such as automatically pausing migrations and providing email notifications of pre-migration and post-migration reports can be provided for different migration services.

FIG. 6 is a flow diagram of an automated workload migration process in an illustrative embodiment. It is to be understood that this particular process is only an example, and additional or alternative processes can be carried out in other embodiments.

In this embodiment, the process includes steps 600 through 608. These steps are assumed to be performed, at least in part by, the automated workload migration system 105 utilizing its elements 112, 114, and 116.

Step 600 includes obtaining one or more requests for migrating a plurality of workloads, wherein the one or more requests comprise information corresponding to one or more characteristics associated with the plurality of workloads. Step 602 includes analyzing the one or more requests by applying one or more migration selection criteria to the one or more characteristics associated with the plurality of workloads. Step 604 includes selecting at least one of a plurality of migration services to use for migrating the plurality of workloads based on a result of the analyzing. Step 606 includes generating a set of instructions to migrate the plurality of workloads using the selected at least one migration service. Step 608 includes automatically triggering the migration of the plurality of workloads based at least in part on the set of instructions.

At least one of the plurality of workloads may include a VM associated with a virtual control station. For example, the virtual control station can correspond to software that is used for managing the VM, and possibly one or more other VMs. The one or more characteristics associated with a given one of the workloads may include one or more identifiers associated with the given workload, a source environment that the given workload is to be migrated from, a target environment that the given workload is to be migrated to, authentication information associated with the given workload, operation system information corresponding to the given workload, and/or network information corresponding to at least one of the source environment and the target environment. The process may further include a step of performing a pre-migration validation process of the selected at least one migration service for migrating the plurality of workloads. The process may include a step of generating one or more confirmation messages in response to the plurality of workloads being successfully migrated. In some embodiments, the process can include determining that the migration of at least one of the plurality of workloads failed and/or automatically re-executing the migration of the failed migration. Applying the one or more migration selection criteria for a given one of the plurality of workloads may include determining that the migration includes at least one physical host being migrated, at least one application being migrated, at least one virtual control station being migrated, at least one datastore being migrated, at least one network adapter being migrated, at least one storage device being migrated, and/or at least one storage device being upgraded. The plurality of migration services may include two or more of the following migration services: a storage area network migration service, a data replication migration service, a data protection migration service, and a physical host migration service. The process may include a step of providing a unified migration user interface for managing the migration of the plurality of workloads across the plurality of migration services. The migration of the plurality of workloads may be automatically performed using two or more of the plurality of migration services.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional workload migration approaches. For example, some embodiments are configured to provide an automated migration framework that can facilitate workload migrations by selecting one or more suitable migration services from a plurality of different migration services for performing the migration. At least some embodiments are also configured to provide automated migration scheduling features, including automatically pausing migrations (e.g., during business hours) and/or automatically re-scheduling failed migrations. Such embodiments can be more efficient in terms of time and/or computing resources and can also result in fewer errors than conventional techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement host devices and storage systems with functionality for automating workload migrations will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100. The cloud infrastructure 700 comprises multiple VMs and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. Such implementations can provide functionality for automating workload migrations of the type described above using one or more processes running on a given one of the VMs. For example, each of the VMs can implement migration interface 102 and/or other components for implementing functionality for automating workload migrations in the host devices 101.

A hypervisor platform may be used to implement a hypervisor within the virtualization infrastructure 704. Such a hypervisor platform may comprise an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system. Such implementations can also provide functionality for automating workload migrations of the type described above. For example, a container host device supporting multiple containers of one or more container sets can implement one or more instances of the automated workload migration system 105, and/or other components for implementing functionality for automating migration of workflows.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), graphics processing unit (GPU) or other type of processing circuitry, as well as portions or combinations of such circuitry elements.

The memory 812 may comprise RAM, read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for automating workload migrations as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, host devices, storage systems, storage devices, storage controllers, and other components. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining one or more requests for migrating a plurality of workloads, wherein the one or more requests comprise information corresponding to one or more characteristics associated with the plurality of workloads;
analyzing the one or more requests by applying one or more migration selection criteria to the one or more characteristics associated with the plurality of workloads;
selecting at least one of a plurality of migration services to use for migrating the plurality of workloads based on a result of the analyzing;
generating a set of instructions to migrate the plurality of workloads using the selected at least one migration service; and
automatically triggering the migration of the plurality of workloads based at least in part on the set of instructions;
wherein the method is performed by at least one processing device comprising a processor coupled to a memory.

2. The computer-implemented method of claim 1, wherein at least one of the plurality of workloads comprises a virtual machine associated with a virtual control station.

3. The computer-implemented method of claim 1, wherein the one or more characteristics associated with a given one of the workloads comprise at least one of:
one or more identifiers associated with the given workload;
a source environment that the given workload is to be migrated from;
a target environment that the given workload is to be migrated to;
authentication information associated with the given workload;
operation system information corresponding to the given workload; and
network information corresponding to at least one of the source environment and the target environment.

4. The computer-implemented method of claim 1, further comprising at least one of:
performing a pre-migration validation process of the selected at least one migration service for migrating the plurality of workloads; and
generating one or more confirmation messages in response to the plurality of workloads being successfully migrated.

5. The computer-implemented method of claim 1, further comprising at least one of:
determining that the migration of at least one of the plurality of workloads failed; and
automatically re-executing the migration of the failed migration.

6. The computer-implemented method of claim 1, wherein the applying the one or more migration selection criteria for a given one of the plurality of workloads comprises determining that the migration comprises at least one of: at least one physical host being migrated, at least one application being migrated, at least one virtual control station being migrated, at least one datastore being migrated, at least one network adapter being migrated, at least one storage device being migrated, and at least one storage device being upgraded.

7. The computer-implemented method of claim 1, wherein the plurality of migration services comprises two or more of: a storage area network migration service; a data replication migration service; a data protection migration service; and a physical host migration service.

8. The computer-implemented method of claim 1, further comprising:
providing a unified migration user interface for managing the migration of the plurality of workloads across the plurality of migration services.

9. The computer-implemented method of claim 1, wherein the migration of the plurality of workloads is automatically performed using two or more of the plurality of migration services.

10. A non-transitory processor-readable storage medium having stored therein program code of one or more software programs, wherein the program code when executed by at least one processing device causes the at least one processing device:
to obtain one or more requests for migrating a plurality of workloads, wherein the one or more requests comprise information corresponding to one or more characteristics associated with the plurality of workloads;
to analyze the one or more requests by applying one or more migration selection criteria to the one or more characteristics associated with the plurality of workloads;
to select at least one of a plurality of migration services to use for migrating the plurality of workloads based on a result of the analyzing;
to generate a set of instructions to migrate the plurality of workloads using the selected at least one migration service; and
to automatically trigger the migration of the plurality of workloads based at least in part on the set of instructions.

11. The non-transitory processor-readable storage medium of claim 10, wherein at least one of the plurality of workloads comprises a virtual machine associated with a virtual control station.

12. The non-transitory processor-readable storage medium of claim 10, wherein the one or more characteristics associated with a given one of the workloads comprise at least one of:
one or more identifiers associated with the given workload;
a source environment that the given workload is to be migrated from;
a target environment that the given workload is to be migrated to;
authentication information associated with the given workload;
operation system information corresponding to the given workload; and
network information corresponding to at least one of the source environment and the target environment.

13. The non-transitory processor-readable storage medium of claim 10, the at least one processing device is further caused to at least one of:
perform a pre-migration validation process of the selected at least one migration service for migrating the plurality of workloads; and
generate one or more confirmation messages in response to the plurality of workloads being successfully migrated.

14. The non-transitory processor-readable storage medium of claim 10, the at least one processing device is further caused to at least one of:
determine that the migration of at least one of the plurality of workloads failed; and
automatically re-execute the migration of the failed migration.

15. The non-transitory processor-readable storage medium of claim 10, wherein the applying the one or more migration selection criteria for a given one of the plurality of workloads comprises determining that the migration comprises at least one of: at least one physical host being migrated, at least one application being migrated, at least one virtual control station being migrated, at least one datastore being migrated, at least one network adapter being migrated, at least one storage device being migrated, and at least one storage device being upgraded.

16. An apparatus comprising:
at least one processing device comprising a processor coupled to a memory;
the at least one processing device being configured:
to obtain one or more requests for migrating a plurality of workloads, wherein the one or more requests comprise information corresponding to one or more characteristics associated with the plurality of workloads;
to analyze the one or more requests by applying one or more migration selection criteria to the one or more characteristics associated with the plurality of workloads;
to select at least one of a plurality of migration services to use for migrating the plurality of workloads based on a result of the analyzing;
to generate a set of instructions to migrate the plurality of workloads using the selected at least one migration service; and
to automatically trigger the migration of the plurality of workloads based at least in part on the set of instructions.

17. The apparatus of claim 16, wherein at least one of the plurality of workloads comprises a virtual machine associated with a virtual control station.

18. The apparatus of claim 16, wherein the one or more characteristics associated with a given one of the workloads comprise at least one of:
one or more identifiers associated with the given workload;
a source environment that the given workload is to be migrated from;
a target environment that the given workload is to be migrated to;
authentication information associated with the given workload;
operation system information corresponding to the given workload; and
network information corresponding to at least one of the source environment and the target environment.

19. The apparatus of claim 16, wherein the at least one processing device is further configured to at least one of:
perform a pre-migration validation process of the selected at least one migration service for migrating the plurality of workloads; and
generate one or more confirmation messages in response to the plurality of workloads being successfully migrated.

20. The apparatus of claim 16, wherein the at least one processing device is further configured to at least one of:
determine that the migration of at least one of the plurality of workloads failed; and
automatically re-execute the migration of the failed migration.
